(19) United States
(12) Patent Application Publication
(10) Pub. No.: US 2026/0269210 A1
(43) Pub. Date: Sep. 10, 2026

(54) Negative Electrode Material for Lithium ION Battery and Modified Preparation Method Thereof

(71) Applicant: National Chung Cheng University, Chiayi (TW)

(72) Inventors: Yuan-Yao LI, Chiayi (TW); Cheng-Liang HUANG, Chiayi (TW); Fang-Jia LIN, Dongshi Township (TW)

(73) Assignee: National Chung Cheng University, Chiayi (TW)

(21) Appl. No.: 19/009,022

(22) Filed: Jan. 3, 2025

(30) Foreign Application Priority Data
Jan. 15, 2024 (TW) 113101498

(51) Int. Cl. H01M 4/04; H01M 4/38; H01M 4/587; H01M 10/0525

(52) U.S. Cl. CPC H01M 4/0404; H01M 4/0419; H01M 4/386; H01M 4/587; H01M 10/0525

(57) ABSTRACT

A modified preparation method of a negative electrode material of a lithium ion battery includes performing a dissolving step, performing a first adding step, performing a second adding step, performing a coating step, and performing a heating step. In the dissolving step, a polyacrylonitrile is dissolved in a N-methylpyrrolidone to form a mixed solution. In the first adding step, an active material and a carbon nanotube are added to the mixed solution, and the carbon nanotube is dispersed uniformly in the mixed solution to form a dispersion. In the second adding step, a conductive carbon black is added to the dispersion to form a slurry. In the coating step, the slurry is coated on a copper foil to form a pole piece. In the heating step, the pole piece is heated to a heating temperature to form the negative electrode material of the lithium ion battery.

### RELATED APPLICATIONS

This application claims priority to Taiwan Application Serial Number 113101498, filed Jan. 15, 2024, which is herein incorporated by reference.

### BACKGROUND

### Technical Field

The present disclosure relates to a negative electrode material of a lithium ion battery. More particularly, the present disclosure relates to a negative electrode material of a lithium ion battery modified with a cyclized polyacrylonitrile and a preparation method thereof.

### Description of Related Art

Due to the increasing demand for the energy storage, the use of lithium ion battery is gradually increasing around the world, and the lithium ion battery can be widely used in the electric vehicles, the mobile phones and the wearable devices. In recent years, many studies have also achieved the good results in other rechargeable secondary batteries, such as the sodium ion battery, the zinc ion battery, the potassium ion battery, lithium-chloride battery, etc. However, in the research of the lithium ion battery, due to the energy density of the conventional graphite anode is too low, which limits the development of the lithium ion battery.

In order to overcome the problem of the graphite anode, the silicon is considered to be one of the most potential material, which has the very high theoretical capacitance (3579 mAh/g), and is quite abundant and easy to obtain on earth. However, the silicon has the problem of more than 300% volume expansion during the charging and discharging. The battery based on the silicon will inevitably encounter alloying of the silicon and the lithium, and the solid electrolyte interface (SEI) will form and break repeatedly. Eventually, the SEI layer will grow fast, and has the disadvantage of the battery efficiency declines and the capacitance decreases rapidly.

Therefore, how to solve the problem encountered by the graphite or the silicon as the negative material for the lithium ion battery, which is the goal of the relevant industry.

### SUMMARY

According to one aspect of the present disclosure, a modified preparation method of a negative electrode material of a lithium ion battery includes the following steps. A dissolving step is performed, wherein a polyacrylonitrile is dissolved in a N-methylpyrrolidone to form a mixed solution. A first adding step is performed, wherein an active material and a carbon nanotube are added to the mixed solution, and the carbon nanotube is dispersed uniformly in the mixed solution to form a dispersion. A second adding step is performed, wherein a conductive carbon black or a graphene is added to the dispersion to form a slurry. A coating step is performed, wherein the slurry is coated on a copper foil to form a pole piece. A heating step is performed, wherein the pole piece is heated to a heating temperature to form the negative electrode material of the lithium ion battery.

According to another aspect of the present disclosure, a negative electrode material of a lithium ion battery is provided. The negative electrode material of the lithium ion battery is fabricated by the modified preparation method of the negative electrode material of the lithium ion battery according to the aforementioned aspect.

### BRIEF DESCRIPTION OF THE DRAWINGS

The present disclosure can be more fully understood by reading the following detailed description of the embodiment, with reference made to the accompanying drawings as follows:

FIG. 1 is a flow chart of a modified preparation method of a negative electrode material of a lithium ion battery according to one embodiment of the present disclosure.

FIG. 2A is a low-resolution transmission electron microscope (TEM) image of Example 1.

FIG. 2B is a low-resolution TEM image of Example 3

FIG. 3A, FIG. 3B, FIG. 3C and FIG. 3D are energy dispersive X-ray spectroscopy (EDS) energy dispersion spectrums of Example 1.

FIG. 4 is a Fourier transform infrared spectroscopy (FTIR) spectrum of Example 1.

FIG. 5 is a constant current charge and discharge diagram of Example 1.

FIG. 6A is a constant current charge and discharge diagram of Example 1 at 1.0 Ag⁻¹.

FIG. 6B is a constant current charge and discharge diagram of Example 1 and Comparative Example 1 at 0.5 Ag⁻¹.

FIG. 7A is a constant current charge and discharge diagram of Example 2 at 0.2 C.

FIG. 7B is a constant current charge and discharge diagram of Comparative Example 2 at 0.2 C.

FIG. 8 is a constant current charge and discharge diagram of Example 3 and Comparative Example 3 at 2.0 Ag⁻¹.

FIG. 9 is a constant current charge and discharge diagram of a first cycle of Example 3, Comparative Example 3 and Comparative Example 4.

FIG. 10 is a Nyquist plot of Example 1.

### DETAILED DESCRIPTION

The present disclosure will be further exemplified by the following specific embodiments. However, the embodiments can be applied to various inventive concepts and can be embodied in various specific ranges. The specific embodiments are only for the purposes of description, and are not limited to these practical details thereof.

### Modified Preparation Method of Negative Electrode Material of Lithium Ion Battery

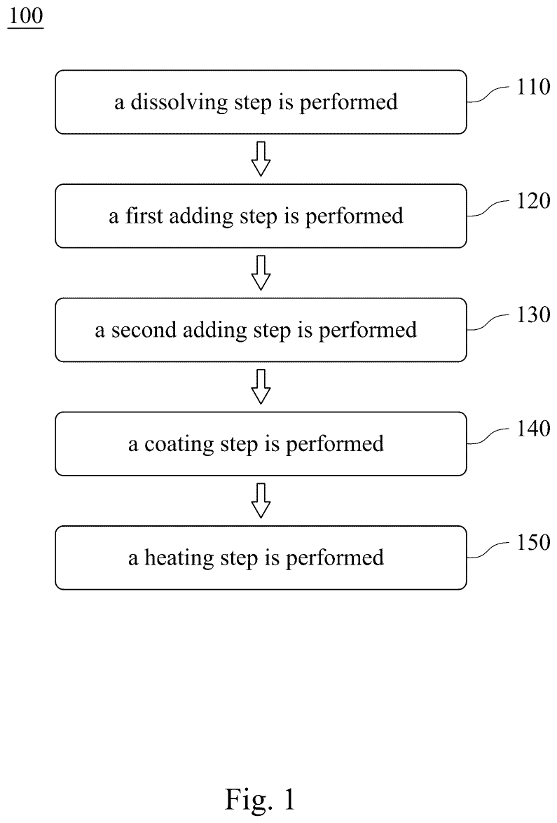

Reference is made to FIG. 1, which is a flow chart of a modified preparation method of a negative electrode material of a lithium ion battery 100 according to one embodiment of the present disclosure. In FIG. 1, the modified preparation method of the negative electrode material of the lithium ion battery 100 includes a step 110, a step 120, a step 130, a step 140 and a step 150.

In the step 110, a dissolving step is performed, wherein a polyacrylonitrile is dissolved in a N-methylpyrrolidone to form a mixed solution.

In the step 120, a first adding step is performed, wherein an active material and a carbon nanotube are added to the mixed solution, and the carbon nanotube is dispersed uniformly in the mixed solution to form a dispersion. The active material can be a carbon material or a silicon material, wherein the carbon material can be but not limited to a graphite or a mesocarbon microbead (MCMB), and the silicon material can be but not limited to a nano-silicon, a micro-silicon, a nano-silicon monoxide, or a micro-silicon monoxide. Furthermore, the carbon nanotube can be a single-walled carbon nanotube (SWCNT) or a multi-walled carbon nanotube (MWCNT), and the two-dimensional conductivity can be improved by adding the carbon nanotube to accelerate the electron conduction rate.

In the step 130, a second adding step is performed, wherein a conductive carbon black or a graphene is added to the dispersion to form a slurry, and the conductivity can be increased by adding the conductive carbon black or the graphene. Specifically, a total weight of the slurry is 100 parts by weight, a content of the polyacrylonitrile is 10 parts by weight to 50 parts by weight, a content of the active material is 30 parts by weight to 70 parts by weight, a content of the carbon nanotube is 0.04 parts by weight to 5 parts by weight and a content of the conductive carbon black or the graphene is 0.1 parts by weight to 20 parts by weight.

In the step 140, a coating step is performed, wherein the slurry is coated on a copper foil to form a pole piece, and a thickness of the slurry coated on the copper foil can be 3 μm to 100 μm. Furthermore, in the coating step, the slurry can be placed in a spray granulator to perform a spray granulation (i.e. anti-solvent spraying process) on the copper foil, so that the pole piece has a plurality of composite particles.

In the step 150, a heating step is performed, wherein the pole piece is heated to a heating temperature to form the negative electrode material of the lithium ion battery. The heating temperature can be 250° C. to 350° C. for 1 hour to 12 hours, so that the polyacrylonitrile will not be carbonized after heating.

Therefore, the negative electrode material of the lithium ion battery of the present disclosure is prepared by the simple slurry mixing technology and performing the heat treatment, which is different from the generally complex synthesis method. In the present disclosure, the polyacrylonitrile (PAN) is used to connect the active material and the conductive material, which can cover the active material to form the shell-like structure. Specifically, the polyacrylonitrile has the rich nitrogen-containing functional groups which can provide the large amount of the pyridinic N to provide the more active sites. In addition, in order to overcome the problem of the silicon expansion and the insufficient conductivity, the carbon nanotube and the conductive material such as the conductive carbon black or the graphene are added to form the conductive network, so that the expanded silicon can be connected with the carbon nanotube and the conductive carbon black or the graphene. Furthermore, in the low temperature environment, the polyacrylonitrile will cyclize to form the cyclized polyacrylonitrile (cPAN). After the cyclization, the C≡N from the polyacrylonitrile is converted to C═N and C—N, so that the overall bond is more stable. The dense cPAN can effectively prevent the electrolyte from contacting directly the active material, promoting the formation of the stable solid electrolyte interphase and improving the initial coulombic efficiency and the electrochemical characteristic. Therefore, the present disclosure uses the cyclized polyacrylonitrile to coat the active material for modification, which is used as the negative electrode material of the lithium ion battery.

### Negative Electrode Material of Lithium Ion Battery

The present disclosure provides a negative electrode material of a lithium ion battery fabricated by the aforementioned modified preparation method of the negative electrode material of the lithium ion battery. Specifically, compared with the previous negative electrode material that uses the binder to attach the precursor powder to the copper foil, the present disclosure uses the simple mixing technology to directly use the polyacrylonitrile as the binder to make the contact between the negative electrode material and the copper foil be closer, and the pyridinic N of the polyacrylonitrile can provide the active site and the electron transfer, which is favorable for improving the overall performance of the lithium ion battery. Furthermore, the large amount of the composite particles can be produced easily by the anti-solvent spray granulation strategy, and the polyacrylonitrile is converted into the cyclized polyacrylonitrile to coat the active material by the low-temperature calcination treatment to limit the expansion of the active material.

The present disclosure will be further exemplified by the following specific embodiments so as to facilitate utilizing and practicing the present disclosure completely by the people skilled in the art without over-interpreting and over-experimenting. However, the readers should understand that the present disclosure should not be limited to these practical details thereof, that is, these practical details are used to describe how to implement the materials and methods of the present disclosure and are not necessary.

### Preparation of Negative Electrode Material of Lithium Ion Battery

Example 1: 0.1 g of the polyacrylonitrile is dissolved in 5 g of the N-methylpyrrolidone and stirred for 30 minutes to form the mixed solution. Next, 0.3 g of the nano-silicon and 0.01 g of the single-walled carbon nanotube are added to the mixed solution and stirred for 30 minutes, and then using the ultrasonic processor to disperse evenly to make the single-walled carbon nanotube disperse evenly in the mixed solution to obtain the dispersion. After that, 0.09 g of the conductive carbon black is added to the dispersion and stirred for 30 minutes to form the slurry, and the slurry is coated on the copper foil with the thickness of 50 μm and vacuum dried at 80° C. for 12 hours to form the pole piece. Finally, the pole piece is placed in the tubular high-temperature furnace flowing with the argon gas, and the temperature is raised from 30° C. to 310° C. at the heating rate of 1° C./minute and maintained for 12 hours to form the negative electrode material of the lithium ion battery of Example 1.

Example 2: 0.1 g of the polyacrylonitrile is dissolved in 5 g of the N-methylpyrrolidone and stirred for 30 minutes to form the mixed solution. Next, 0.3 g of the mesocarbon microbead (MCMB) and 0.01 g of the single-walled carbon nanotube are added to the mixed solution and stirred for 30 minutes, and then using the ultrasonic processor to disperse evenly to make the single-walled carbon nanotube disperse evenly in the mixed solution to obtain the dispersion. After that, 0.09 g of the conductive carbon black is added to the dispersion and stirred for 30 minutes to form the slurry, and the slurry is coated on the copper foil with the thickness of 50μm and vacuum dried at 80° C. for 12 hours to form the pole piece. Finally, the pole piece is placed in the tubular high-temperature furnace flowing with the argon gas, and the temperature is raised from 30° C. to 310° C. at the heating rate of 1° C./minute and maintained for 12 hours to form the negative electrode material of the lithium ion battery of Example 2.

Example 3: the micro-silicon, the polyacrylonitrile, the graphene and the carbon nanotube in the ratio of 49.4:49.4:0.3:0.9 and 5 g of the N-methylpyrrolidone are mixed and stirred for 30 minutes to form the slurry. Then, the slurry is connected to the spray granulator to perform the spray granulation, and the composite particles are formed on the copper coil to obtain the pole piece. Finally, the pole piece is placed in the tubular high-temperature furnace flowing with the argon gas, and the temperature is raised from 30° C. to 300° C. at the heating rate of 1° C./minute and maintained for 12 hours to form the negative electrode material of the lithium ion battery of Example 3.

Comparative Example 1: the nano-silicon and the polyacrylonitrile in the ratio of 80:20 and 5 g of the N-methylpyrrolidone are mixed and stirred for 30 minutes to form the slurry. Then, the slurry is coated on the copper foil with the thickness of 50 μm and vacuum dried at 80° C. for 12 hours to form the pole piece. Finally, the pole piece is placed in the tubular high-temperature furnace flowing with the argon gas, and the temperature is raised from 30° C. to 310° C. at the heating rate of 1° C./minute and maintained for 12 hours to form the negative electrode material of the lithium ion battery of Comparative Example 1.

### Property Analysis of Negative Electrode Material of Lithium Ion Battery

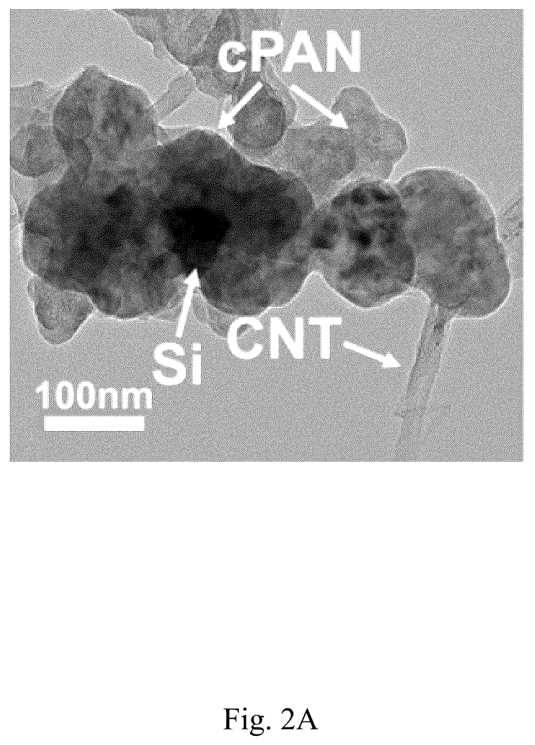

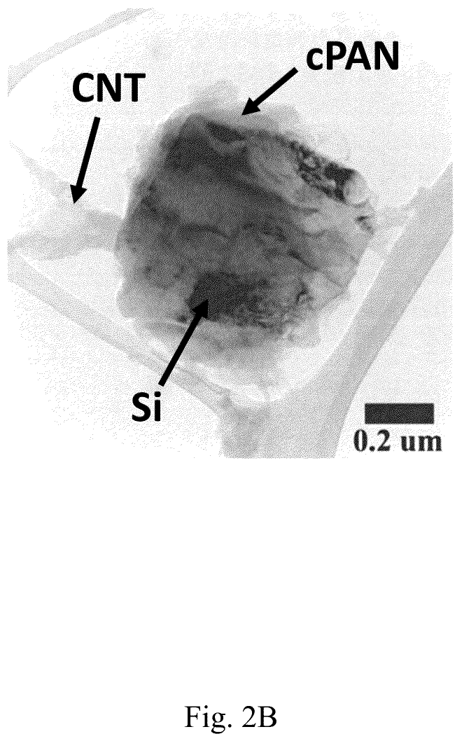

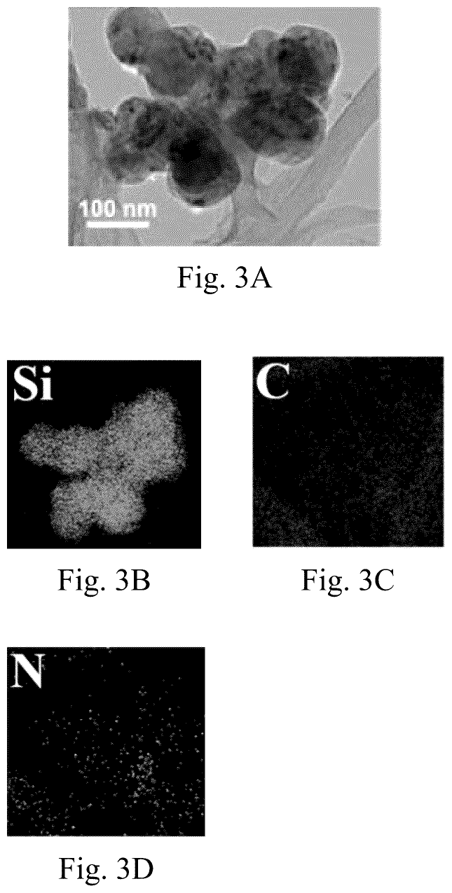

Reference is made to FIG. 2A, FIG. 2B, FIG. 3A, FIG. 3B, FIG. 3C and FIG. 3D, wherein FIG. 2A is a low-resolution transmission electron microscope (TEM) image of Example 1, FIG. 2B is a low-resolution TEM image of Example 3, and FIGS. 3A to 3D are energy dispersive X-ray spectroscopy (EDS) energy dispersion spectrums of Example 1. As shown in FIG. 2A and FIG. 2B, the silicon (dark area in FIG. 2A and FIG. 2B) is completely covered by the cyclized polyacrylonitrile (cPAN), and the network formed by the carbon nanotube (CNT) is also can be seen nearby to make the electron transfer smoother. Furthermore, as shown in FIG. 3A to FIG. 3D, the silicon is distributed in the center and its periphery is covered by the cyclized polyacrylonitrile (cPAN), which is corresponding to FIG. 2A. The distribution of the nitrogen overlaps with the carbon, which is due to the polyacrylonitrile has C≡N functional group, and C≡N is converted to C═N and C—N after the cyclization to make the overall structure more stable.

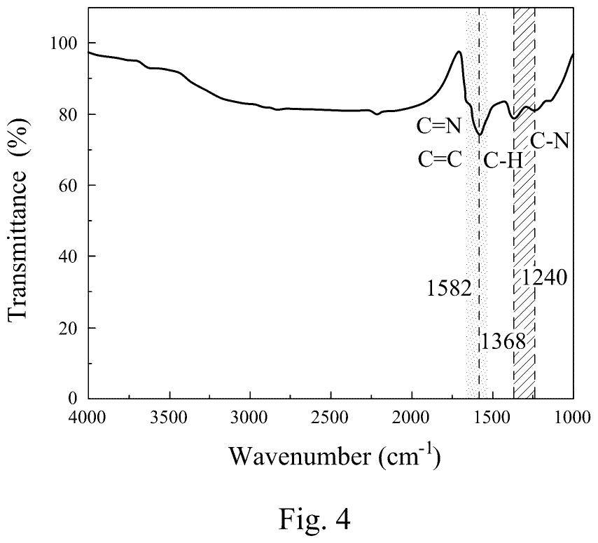

Reference is made to FIG. 4, which is a Fourier transform infrared spectroscopy (FTIR) spectrum of Example 1. Specifically, the original position of the polyacrylonitrile is located at 2944 cm⁻¹, 2246 cm⁻¹ and 1454 cm⁻¹, which are corresponded to CH₂ bond, C≡N bond and C—N bond, respectively. However, as shown in FIG. 4, the polyacrylonitrile after cyclization does not have the obvious peak at 2246 cm⁻¹, proving that the polyacrylonitrile has been successfully cyclized. Furthermore, the positions of 1582 cm⁻¹, 1368 cm⁻¹ and 1240 cm⁻¹ are corresponded to C═N bond, C—H bond and C—N bond, respectively, indicating that the C≡N of the polyacrylonitrile is converted to C═N and C—N of the cyclized polyacrylonitrile after the low temperature calcination, which is favorable for improving the electrochemical effect.

### Electrochemical Test Analysis

The electrochemical test of the present disclosure is performed with the button battery. The negative electrode material of the lithium ion battery of Example 1, Example 2, Example 3 and Comparative Example 1 is used as the working electrode, the lithium metal sheet is used as the counter electrode, and 1M of LiPF₆ is used as the electrolyte, so as to perform the galvanostaic charge and discharge test and the electrochemical impedance spectroscopy (EIS) test.

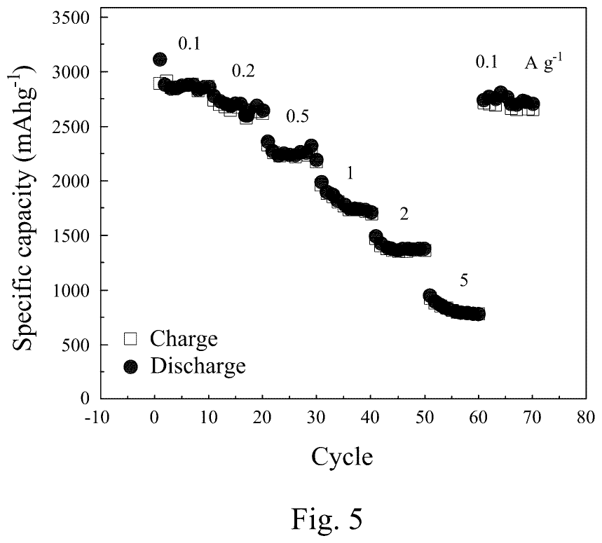

Reference is made to FIG. 5, which is a constant current charge and discharge diagram of Example 1. As shown in FIG. 5, the specific capacitance of 2871.1, 2652.8, 2194.5, 1716.3, 1380.9, 783.8 mAhg⁻¹ can be obtained at the charge and discharge rate of 0.1, 0.2, 0.5, 1.0, 2.0, 5.0 Ag⁻¹, respectively. When the charge and discharge rate is returned from 5.0 Ag⁻¹ to 0.1 Ag⁻¹, the specific capacitance is returned to 2746.1 mAhg⁻¹, and the retention rate is reached to 95.7% to show the great reversible cycle performance.

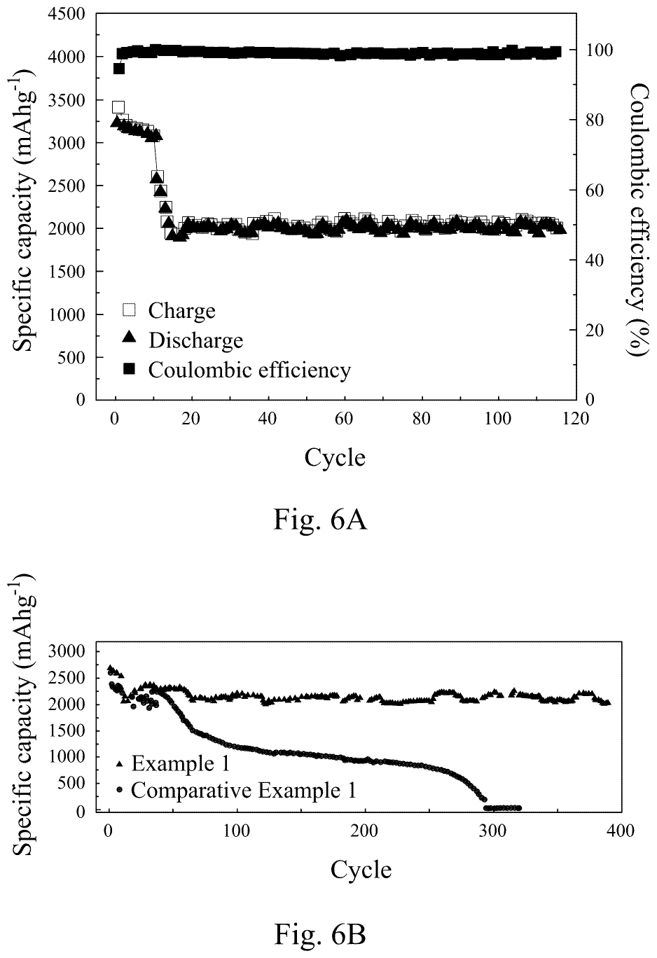

Reference is made to FIG. 6A and FIG. 6B, wherein FIG. 6A is a constant current charge and discharge diagram of Example 1 at 1.0 Ag⁻¹, and FIG. 6B is a constant current charge and discharge diagram of Example 1 and Comparative Example 1 at 0.5 Ag⁻¹. As shown in FIG. 6A and FIG. 6B, at the charge and discharge rate of 1.0 Ag⁻¹, the specific capacitance of the first cycle of Example 1 is 3416.66 mAhg⁻¹, and the initial coulombic efficiency (ICE) is 94.23%. After the 100th cycles, the specific capacitance of Example 1 is still 2071.99 mAhg⁻¹. Compared with the 14th cycles after the activation, the retention rate is 99.86%. However, at the charge and discharge rate of 0.5 Ag⁻¹, the specific capacitance of the first cycle of Example 1 is 2695.5 mAhg⁻¹. After the 390th cycles, Example 1 still has the high specific capacitance of 2022.4 mAhg⁻¹, and the retention rate is 89.2%. On the contrary, in Comparative Example 1, due to the conductivity of the silicon and the cyclized polyacrylonitrile is quite low, resulting in the low electron transmission efficiency, so that only 1193.9 mAhg⁻¹ of the specific capacitance is remained after the 100th cycles, and the performance of the retention rate is poor.

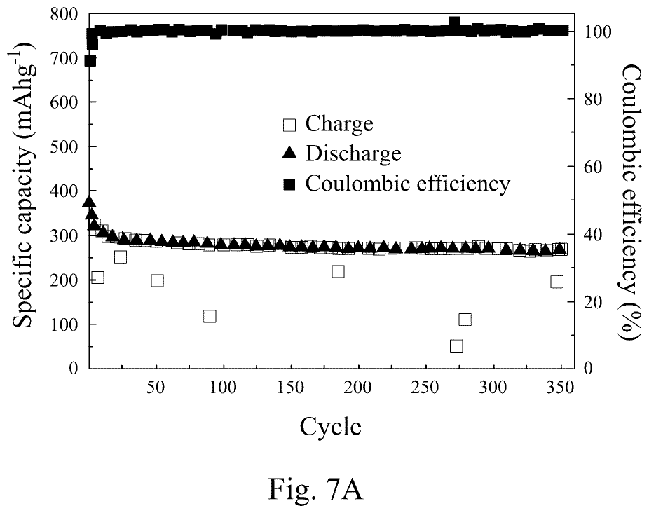

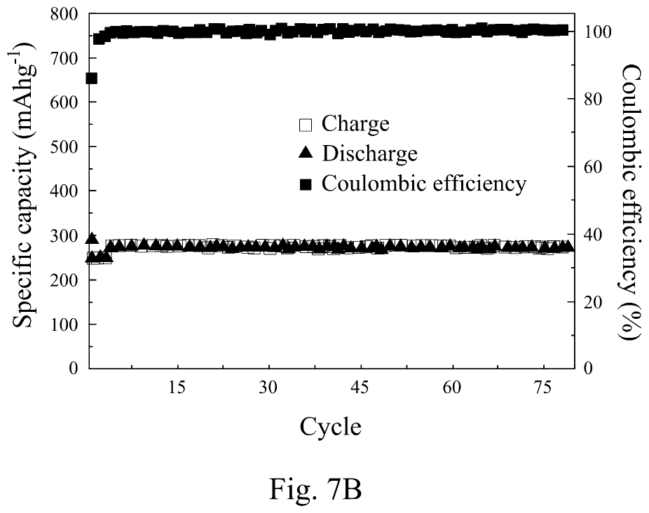

Moreover, reference is made to FIG. 7A and FIG. 7B, wherein FIG. 7A is a constant current charge and discharge diagram of Example 2 at 0.2 C, and FIG. 7B is a constant current charge and discharge diagram of Comparative Example 2 at 0.2 C. Comparative Example 2 uses the polyvinylidene difluoride (PVDF) as the binder of the mesocarbon microbead. As shown in FIG. 7A and FIG. 7B, at the charge and discharge rate of 0.2 C, the specific capacitance of the first cycle of Example 2 is 375.32 mAhg⁻¹, and the initial coulombic efficiency (ICE) is 90.89%. However, the specific capacitance of the first cycle of Comparative Example 2 is 293.85 mAhg⁻¹, and the initial coulombic efficiency (ICE) is 85.74%. It is indicated that the negative electrode material of the lithium ion battery of the present disclosure modified with the cyclized polyacrylonitrile has the better specific capacitance and the initial coulombic efficiency than the negative electrode material of the lithium ion battery of the previous technology using the polyvinylidene difluoride as the binder.

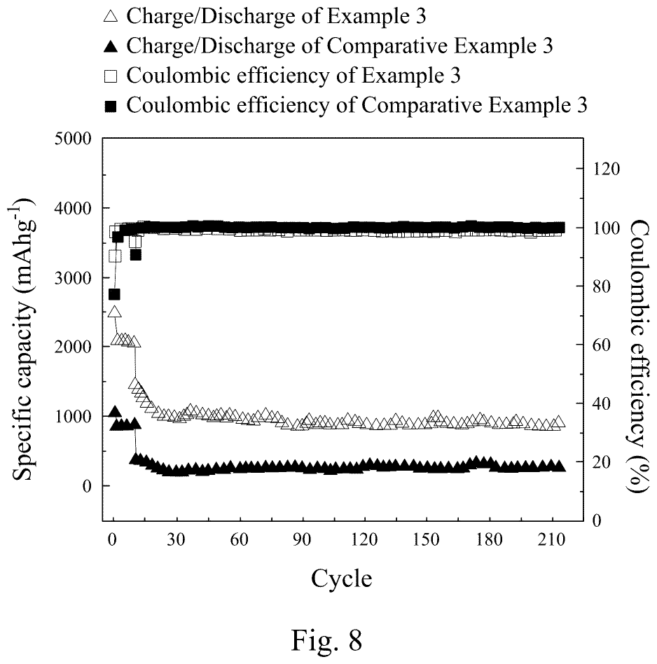

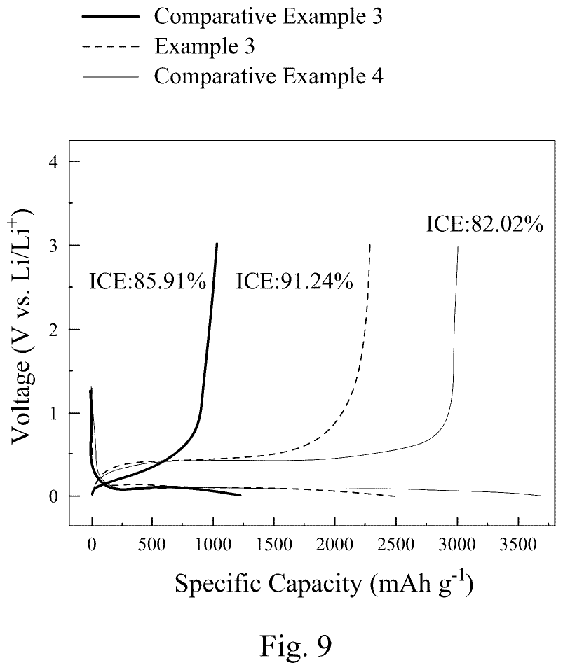

Reference is made to FIG. 8 and FIG. 9, wherein FIG. 8 is a constant current charge and discharge diagram of Example 3 and Comparative Example 3 at 2.0 Ag⁻¹, FIG. 9 is a constant current charge and discharge diagram of a first cycle of Example 3, Comparative Example 3 and Comparative Example 4. Comparative Example 3 is a Si/C composite and Comparative Example 4 is a micro-silicon. As shown in FIG. 8, at the charge and discharge rate of 2.0 Ag⁻¹, the specific capacitance of the first cycle of Example 3 is 2500 mAhg⁻¹, and the initial coulombic efficiency (ICE) is 90%. However, the specific capacitance of the first cycle of Comparative Example 3 is 1000 mAhg⁻¹, and the initial coulombic efficiency (ICE) is 75%. Furthermore, as shown in FIG. 9, compared with Comparative Example 3 and Comparative Example 4, Example 3 has the better initial coulombic efficiency. The results indicate that the negative electrode material of the lithium ion battery of the present disclosure using the anti-solvent spray process to make the cyclized polyacrylonitrile coat the micro-silicon has the better specific capacitance and the initial coulombic efficiency than the Si/C composite and the micro-silicon.

Furthermore, the Nyquist plot obtained by the electrochemical impedance analysis test can be divided into two parts, which are a semicircle in the high-frequency region and a straight line in the low-frequency region, and the equivalent circuit diagram can be inferred from the semicircle in the high-frequency region. The resistances that may occur in the chemical reaction between the lithium ion and the silicon-based substrate are the resistance of the lithium ion entering the pole piece by the electrolyte (Resistance of electrolyte, Rₑ), the resistance of the lithium ion entering the SEI layer (Resistance of SEI layer, R_{SEI}), the resistance of the lithium ion from the SEI layer to the surface of the electrode material (Resistance of charge-transfer, R_{ct}) and the resistance of the final diffusion of the lithium ion to the electrode material (Warburg impedance, Z_{w}), respectively.

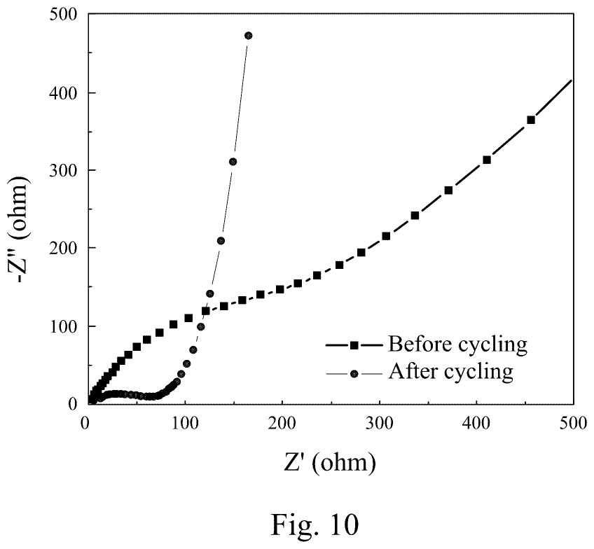

Reference is made to FIG. 10, which is a Nyquist plot of Example 1. As shown in FIG. 10, in the state of the battery (before cycling), the R_{ct} is 101.5 ohm, and after the 390th cycles of charge and discharge at the charge and discharge rate of 0.5 Ag⁻¹, the R_{SEI} and the R_{ct} are 35.2 ohm and 40.5 ohm, respectively, indicating that the R_{ct} of Example 1 before and after cycling is not high, so that is has the good conductivity and the lithium ion transport effect.

In conclusion, the negative electrode material of the lithium ion battery has the advantages described following. First, the polyacrylonitrile is directly used as the binder by a one-step mixing technology, so that the contact between the negative electrode material and the copper foil is closer, and there is not necessary to prepare the precursor powder and then use other binder to attach it to the copper foil. Second, the carbon nanotube and the conductive carbon black are distributed around the active material and the polyacrylonitrile largely, so that the electron transmission is more efficiency. Third, the cyclized polyacrylonitrile can not only be used as the binder, but also as the active material, and the nitrogen functional group of the cyclized polyacrylonitrile has the rich pyridinic N to provide the more active sites and the electron transfer, which is favorable for improving the overall performance of the lithium ion battery. Fourth, the cyclized polyacrylonitrile coats the active material by the anti-solvent spray process and the heat treatment can effectively prevent the electrolyte from contacting directly the active material, promoting the formation of the stable solid electrolyte interphase and improving the initial coulombic efficiency and the electrochemical characteristic. Therefore, the negative electrode material of the lithium ion battery of the present disclosure is modified by the cyclized polyacrylonitrile, which has the good performance under the long-term and the high-current charging and discharging condition.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A modified preparation method of a negative electrode material of a lithium ion battery, comprising:
performing a dissolving step, wherein a polyacrylonitrile is dissolved in a N-methylpyrrolidone to form a mixed solution;
performing a first adding step, wherein an active material and a carbon nanotube are added to the mixed solution, and the carbon nanotube is dispersed uniformly in the mixed solution to form a dispersion;
performing a second adding step, wherein a conductive carbon black or a graphene is added to the dispersion to form a slurry;
performing a coating step, wherein the slurry is coated on a copper foil to form a pole piece; and
performing a heating step, wherein the pole piece is heated to a heating temperature to form the negative electrode material of the lithium ion battery.

2. The modified preparation method of the negative electrode material of the lithium ion battery of claim 1, wherein in the coating step, the slurry is placed in a spray granulator to perform a spray granulation on the copper foil, so that the pole piece has a plurality of composite particles.

3. The modified preparation method of the negative electrode material of the lithium ion battery of claim 1, wherein the active material is a carbon material or a silicon material.

4. The modified preparation method of the negative electrode material of the lithium ion battery of claim 3, wherein the carbon material is a graphite or a mesocarbon microbead.

5. The modified preparation method of the negative electrode material of the lithium ion battery of claim 3, wherein the silicon material is a nano-silicon, a micro-silicon, a nano-silicon monoxide, or a micro-silicon monoxide.

6. The modified preparation method of the negative electrode material of the lithium ion battery of claim 1, wherein a total weight of the slurry is 100 parts by weight, a content of the polyacrylonitrile is 10 parts by weight to 50 parts by weight.

7. The modified preparation method of the negative electrode material of the lithium ion battery of claim 1, wherein a total weight of the slurry is 100 parts by weight, a content of the active material is 30 parts by weight to 70 parts by weight.

8. The modified preparation method of the negative electrode material of the lithium ion battery of claim 1, wherein a total weight of the slurry is 100 parts by weight, a content of the carbon nanotube is 0.04 parts by weight to 5 parts by weight.

9. The modified preparation method of the negative electrode material of the lithium ion battery of claim 1, wherein a total weight of the slurry is 100 parts by weight, a content of the conductive carbon black or the graphene is 0.1 parts by weight to 20 parts by weight.

10. The modified preparation method of the negative electrode material of the lithium ion battery of claim 1, wherein a thickness of the slurry coated on the copper foil is 3 μm to 100 μm.

11. The modified preparation method of the negative electrode material of the lithium ion battery of claim 1, wherein the heating temperature is 250° C. to 350° C. for 1 hour to 12 hours.

12. A negative electrode material of a lithium ion battery fabricated by the modified preparation method of the negative electrode material of the lithium ion battery of claim 1.
